(19) United States
(12) Patent Application Publication
(10) Pub. No.: US 2003/0038733 A1
(43) Pub. Date: Feb. 27, 2003

(54) Access control system and method

(76) Inventors: Robin Willats, Preston (GB); John Emson, West Midlands (GB); Sidney Fisher, Redditch (GB); Jean-Bernard Didier, Anould (FR); Alan Dixon, Chester (GB); Stephen Drysdale, Northampton (GB); Nigel Spurr, Solihull (GB); Gurbinder Kalsi, West Midlands (GB)

Correspondence Address: CARLSON, GASKEY & OLDS, P.C., 400 WEST MAPLE ROAD, SUITE 350, BIRMINGHAM, MI, 48009, US

(21) Appl. No.: 10/215,274

(22) Filed: Aug. 8, 2002

(30) Foreign Application Priority Data
Aug. 10, 2001 (GB) GB 0119513.0
Aug. 10, 2001 (GB) GB 0119511.4

(51) Int. Cl. G08C 19/00

(52) U.S. Cl. 340/825.72

(57) ABSTRACT

An access control system for a vehicle having at least two closures, the system comprising a receiver that determines the angular position of an associated authorization device relative to the receiver allowing the system to determine the appropriate vehicle closure or closures to open. The system is able to determine additional closures to be opened in accordance with predetermined criteria in response to the period of time for which an input signal is received by the system from the authorization device.

### CROSS REFERENCE TO RELATED APPLICATIONS

This application claims priority to United Kingdom (GB) Patent Application No. 0119513.0 filed Aug. 10, 2001 and United Kingdom (GB) Patent Application No. 0119511.4 filed Aug. 10, 2001.

### TECHNICAL FIELD

The present invention relates to an access control system and an access control method. More particularly, the present invention relates to an access control system and an access control method that determines an appropriate closure or closures of an associated vehicle to be unlocked and or unlatched depending upon the direction of approach of a vehicle user and inputs from the vehicle user.

### BACKGROUND OF THE INVENTION

The use of active remote keyless entry (RKE) devices such as ultrasonic or infra-red type transmitters carried by a vehicle user and which remotely signal the unlocking of vehicle closures (e.g. side doors, rear tailgate, hatchback, boot/trunk lid) once actuated by the user is known. Similarly, passive remote keyless entry devices comprising a transponder carried by a vehicle user that may be interrogated by a transceiver associated with a vehicle in order to unlatch the vehicle closures are also known.

However, when either system is used, once the access control system associated with the vehicle has determined that access is to be permitted, it is usual that all closures are unlocked.

When a vehicle user approaches a vehicle it is usual for him/her to proceed directly towards the closure at which they wish to enter the passenger compartment or storage area of the vehicle, without first carrying out a visual inspection around the perimeter of the vehicle. This behavior enables an unauthorized person such as a potential hijacker to hide behind the vehicle in a blind spot and subsequently gain unauthorized access to the vehicle once all of the closures are unlocked. Clearly, such a situation is undesirable.

The present invention seeks to overcome, or at least mitigate the aforesaid problem.

### SUMMARY OF THE INVENTION

One aspect of the present invention provides an access control system for a vehicle having at least two closures, the system comprising a receiving means, the receiving means being so constructed and arranged as to determine the angular position of an associated authorization device relative to the receiving means thereby enabling the system to determine the appropriate vehicle closure(s) to unlock and/or unlatch, the system being capable of determining additional closures to be unlocked and/or unlatched in accordance with predetermined criteria in response to the period of time for which an input signal is received by the system from the authorization device.

A second aspect of the present invention provides a method of unlocking and/or unlatching a selected one or more closures of a vehicle having at least two said closures, the method comprising the steps of: i) providing an access control system comprising receiving means capable of determining the angular position of an associated authorization device relative to the receiving means; ii) the receiving means receiving a signal from the authorization device; iii) the system determining the angle from which the signal was received and the duration of the signal; iv) the system signalling the unlocking and/or unlatching of one or more of the closures in response to the determined angle and signal duration in accordance with predetermined criteria.

A third aspect of the present invention provides an access control system for a vehicle having at least two closures, the system comprising receiving means, the receiving means being so constructed and arranged as to determine the angular position of an associated authorization device relative to the receiving means thereby enabling the system to determine the appropriate vehicle closure(s) to unlock and/or unlatch, the system being capable of distinguishing between two levels of authorization, such that the system is programmed not to signal the locking and/or unlatching of one or more closures irrespective of the relative position of an authorization device having a first level of authorization, but does not permit the unlocking or unlatching of the one or more closures in response to an authorization device having a second level of authorization.

The various features and advantages of this invention will become apparent to those skilled in the art from the following detailed description of the currently preferred embodiment. The drawings that accompany the detailed description can be briefly described as follows.

### BRIEF DESCRIPTION OF THE DRAWINGS

FIG. 1 is a view of a transmitting and receiving means of an access control system according to one embodiment of the present invention.

FIG. 2 is a plan view of a vehicle illustrating the access control system in use.

FIG. 3 is a receiving means for use in an access control system according to a second embodiment of the present invention.

FIG. 4 is a plan view of a vehicle illustrating the access control system of the second embodiment of the present invention in use.

FIG. 5 is a schematic block diagram illustrating the access control system of the first embodiment fitted in a vehicle.

FIG. 6 is a schematic block diagram illustrating the access control system according to a second embodiment of the invention.

FIG. 7 is a flow chart illustrating the operation of the system.

### DETAILED DESCRIPTION OF THE EMBODIMENTS

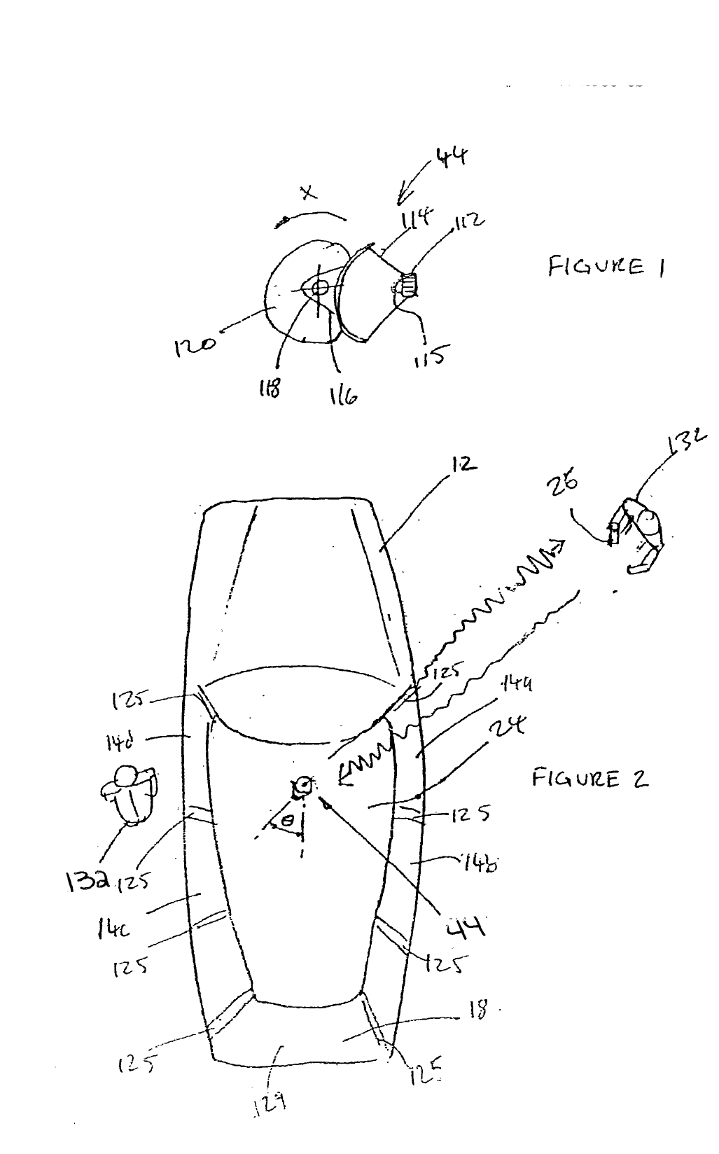

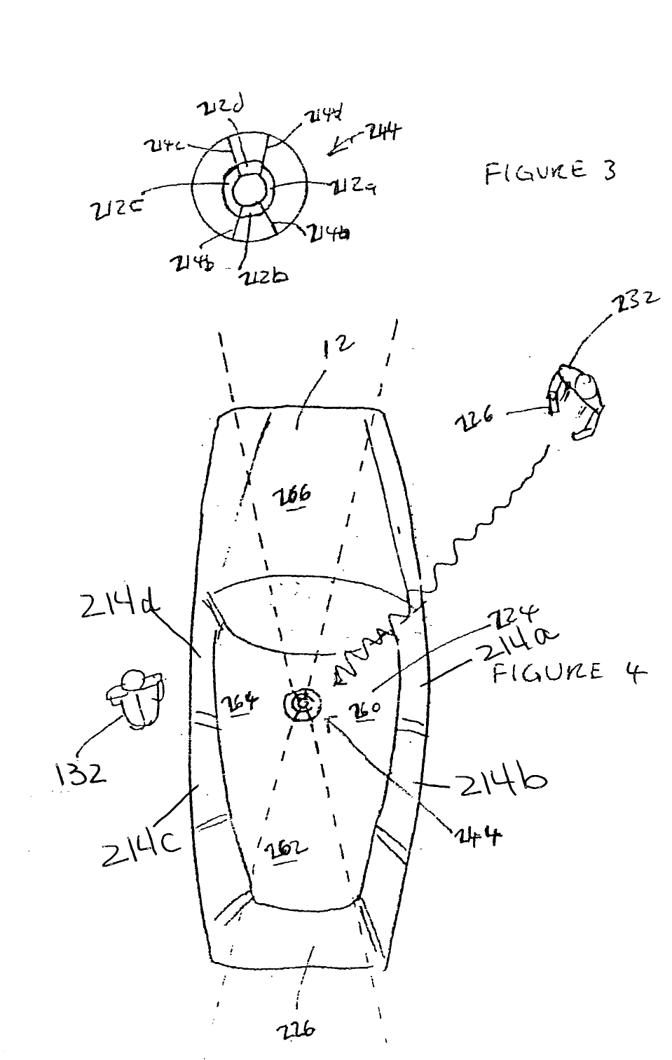

Referring to FIG. 1, there is shown a combined external transmitting and receiving means (hereinafter referred to as transceiver 44). The transceiver 44 comprises a transmitter 115 and a receiver 112 mounted at the narrow end of a mouth 114. The transmitter 115 transmits and the receiver 112 detects signals of a suitable form of electromagnetic radiation or sound waves. In a preferred embodiment, radio frequency (RF) waves such as microwaves are transmitted and detected. The angle over which the signal is transmitted and detected is limited by the angle between the sides of the mouth 114. It can be seen that in FIG. 2, the angle is approximately 90°, although it may be varied according to particular user requirements.

The transmitter 115, receiver 112 and mouth 114 are fixedly mounted on a rotatable shaft 118 by a bracket 116, the shaft 118 being an output shaft of a motor (not shown) such as a suitable electric motor arranged to enable the transmitter, receiver and dish to rotate in a direction X about an axis substantially perpendicular to the axis in which transmitter is directed. A rotary encoder 120 is provided to determine the relative rotary position of the receiver 112.

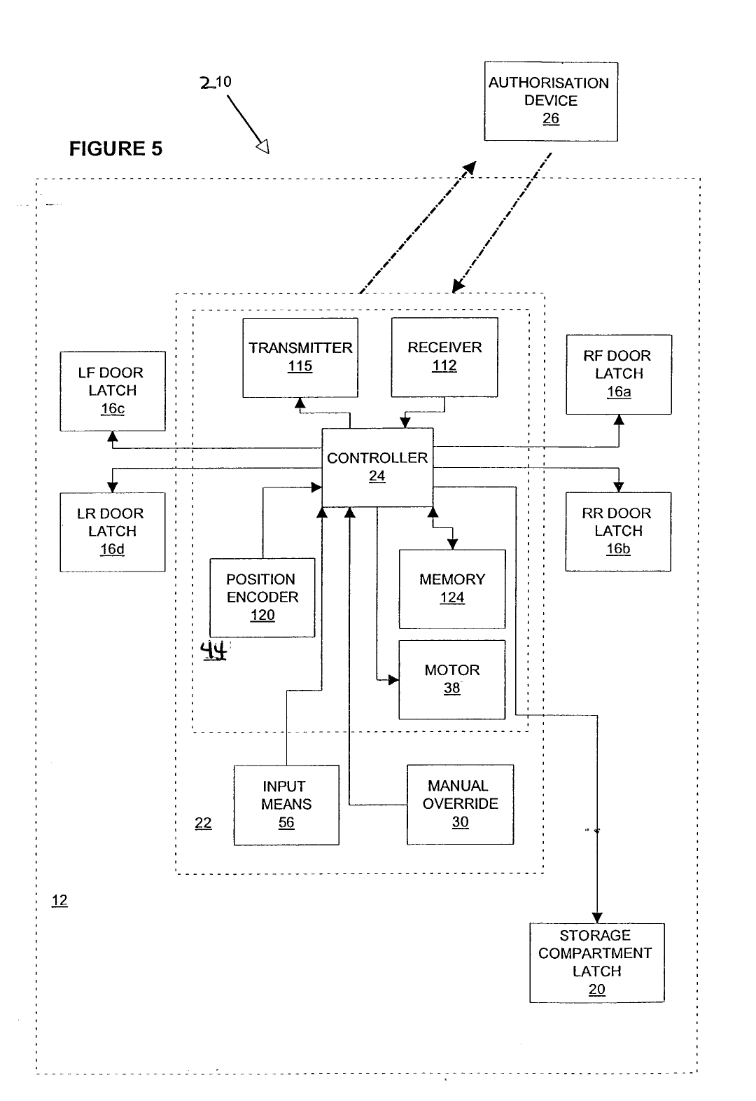

Turning now to FIGS. 2 and 5, a five door estate (station wagon) type vehicle 12 is illustrated having four side doors 14a, 14b, 14c, 14d to access the passenger compartment 22 and rear tailgate 18 to access the storage compartment 129. Door latches 16a, 16b, 16c, 16d, having power locking mechanisms are associated with each door. A further latch 20 with a power locking mechanism is associated with the rear tailgate 18. However, the present invention may be usefully provided in any vehicle having at least two closures. The transceiver 44 is mounted on the vehicle 12 in a position where a substantially unobstructed 360° signal transmission and reception may occur. In this embodiment the transceiver 44 is mounted to the underside of the roof of the passenger compartment 22 of the vehicle. In this position, transmission and reception is only hindered by the relatively narrow door pillars 125 of the vehicle. A controller 24 controls the overall function of the system and has associated therewith memory 124. A manual override 30 and input means 56 (which may in practice be the same component) provide further inputs to the controller 24.

Under normal operating conditions when power is supplied to the system from, for example, a vehicle battery (not shown) the controller 24 signals the motor to cause the transceiver 44 to rotate continuously through a full 360° arc while simultaneously signalling the transmitter 115 to transmit an interrogation signal so as to locate any authorization device (AD) 26 in range. In this embodiment the AD 26 is in the form of a transponder card or the like normally carried by an authorized vehicle user 132.

If a compatible authorization device AD 26 is located within the range of the transmitter 115, the interrogation signal causes AD 26 to power-up and transmit a corresponding coded response signal to the receiver 112. Because the signal is sent using electromagnetic radiation, the response signal is sent almost instantaneously and there is therefore no danger of the transceiver 44 having rotated out of range of the response signal when it is sent. The rate of rotation of the transceiver 44 is advantageously sufficiently high to ensure that approaching authorized users are detected before reaching the vehicle 12.

When a signal is detected by the receiver 112 it is transmitted to the controller 24 for authentication. If it is determined that the AD 26 is authorized for the particular vehicle 12 in question, the controller 24 queries the position encoder 120 of the transceiver 44 as to the angle θ of the transceiver 44 at the point at which a signal from the AD 26 was received by the receiver 112. The controller 24 then compares this angle θ to values stored within the memory 124 associated with the controller. For a given range of angles, the memory stores a predetermined instruction as to which of the vehicle latches 16a, 16b, 16c, 16d, 20 should be unlocked. The controller 24 processes this instruction and signals the door lock actuator (not shown) of an appropriate one or more of the right front, right rear, left front and left rear door latches 16a, 16b, 16c, 16d for doors 14a, 14b, 14c and 14d to unlock respectively as well as storage compartment closure lock actuator (not shown) for the tailgate 18.

For example, if an authenticated signal is received from the AD 26, as shown in FIG. 3, the angular position θ of this is determined by the position encoder 120 as being approximately 45°. The controller 24 then determines from its associated memory 124 that the authorized user 132 is at the right hand side of the vehicle and will thus signal the door lock actuators to unlock the right front and right rear door latches 16a, 16b. If, however, the AD 26 is detected at an angle θ of approximately 180°, the controller 24 will signal the unlocking of the storage compartment latch 20 and if an angle θ of 270° is detected, the controller will signal the unlocking of the left front and left rear door lock actuators to unlock latches 16c, 16d.

Where two or more persons carrying ADs 26 approach different sides of the vehicle 12, the access control system 10 signals the unlocking of vehicle doors on both sides of the vehicle.

In one embodiment, two levels of authorization may exist, one for an authorized vehicle driver, and a second for authorized vehicle passengers. In this embodiment, the controller 24 distinguishes between the authorization levels and only unlocks the driver's door latch 16 (e.g., front door latches 16a or 16c) if a person carrying an AD 26 having a driver's level of authorization approaches this side of the vehicle. If a person 132 carrying an AD 26 enters the vehicle, and wishes to permit entry to other users not carrying ADs, a manual override 30 is provided in an accessible location to cause additional, although not necessarily all of the vehicle closures 14a, 14b, 14c, 14d, 18 to be unlocked. The manual override 30 may also enable the doors to be locked when the vehicle 12 is occupied.

To lock the vehicle once an authorized user 132 has exited the passenger compartment 22, a delay timer (not shown) coupled to a latch position sensor (not shown) may be built into the access control system 10 to cause the controller 24 to signal locking once a certain time has elapsed after the vehicle 12 has been exited. Alternatively, locking occurs once the AD 26 has left the range of the transceiver 44.

If the vehicle is left unattended for an extended period of time (e.g. airport parking) rotation of the transceiver 44 may be suspended or the rate of rotation reduced to reduce the power consumption thereof and thereby minimize the risk of a flat battery upon the user's return to the vehicle. The transmitter power may also be reduced to minimize power consumption. If rotation is suspended, it is preferable for the transceiver 44 to be directed towards the driver's door 14a during suspension as it is most likely that the authorized user 132 will approach this door first. Once a user is detected, the rotation recommences. Optionally, the motion sensor (not shown) be integrated into the system so that the transceiver 44 may be powered down while the vehicle is moving.

In one class of embodiments the system 10 is programmable by the authorized user or by workshop personnel to change the range of angles over which certain closures are unlocked, as well as the particular closures to be unlocked over each angle so that the system may be tailored to user requirements. For this to be achieved, the system of this embodiment employs input means 56.

One advantage of this embodiment is that a transceiver 44 having a relatively narrow angle of signal transmission may require a reduced power consumption, or have a longer range for the same power consumption in comparison with known passive entry transmitting devices.

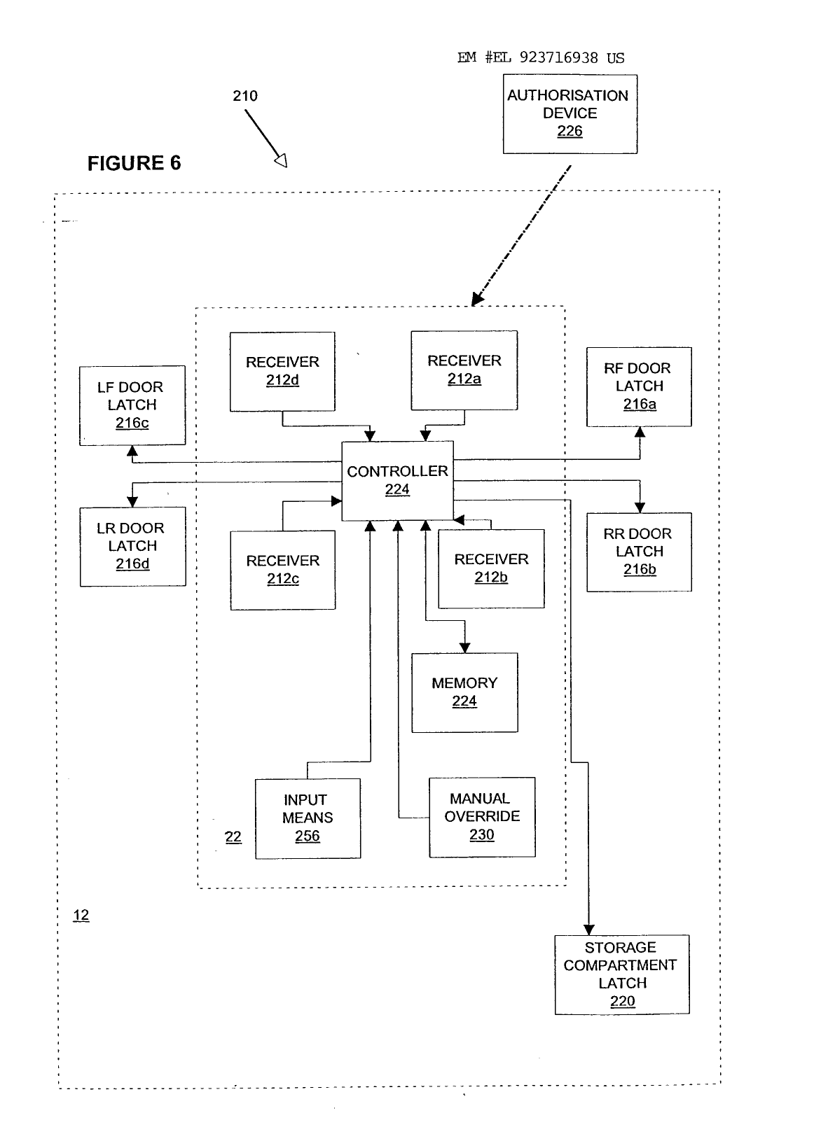

Turning now to FIGS. 3, 4 and 6 and to a second embodiment of the present invention is disclosed in which like numerals have, where possible, been used for like parts with the addition of the prefix “2” as compared with FIGS. 1 and 2.

This embodiment differs from the first embodiment in that no transmitter is provided as part of the access control system 210, and in that the receiver 244 is stationary. As shown in FIG. 3, the receiver 244 in this embodiment comprises in this embodiment four separate directional receivers designated 212a, 212b, 212c and 212d.

The horizontal angle over which each receiver is capable of detecting a signal is restricted by vertical dividers 214a, 214b, 214c and 214d. Thus, by providing multiple receivers it is unnecessary for the receiver to rotate as in the first embodiment, since the angular position of the AD 226 can be detected dependent upon which receiver 212a, 212b, 212c, 212d a signal therefrom is incident.

Referring to FIG. 4, the receiver 244 is shown located in a similar position to the transceiver 44 of the first embodiment and as such effectively divides the area surrounding the vehicle into four sectors 260, 262, 264 and 266 which substantially correspond to the right side, rear, left side and front of the vehicle respectively. In one class of embodiments, receiver 212d may be omitted since no closure suitable for unlocking using the system is provided at the front of the vehicle 212.

The second embodiment is intended for use with an “active” remote keyless entry (RKE) ADs (commonly known as a “plip”) or passive entry systems in which the AD transmits periodic signal without being interrogated by a transceiver. RKE ADs 226 generally comprise an infra-red, radiofrequency or ultrasonic transmitter and have their own power source such as a battery. Because the user themselves actively sends an unlocking signal to the receiver 244 or the AD 226 sends a periodic signal, it is unnecessary to provide a corresponding transmitter on the vehicle 12 to actively search for and interrogate the AD as in the previous embodiment. Once a signal is received from the AD 226, the controller 224 of the access control system 210 determines the appropriate closure(s) to unlock and sends unlock signals to the corresponding lock actuator(s) of latches 216a, 216b, 216c, 216d, 220 in a similar manner to the controller 24 of the first embodiment. Again, the manual override 230 may be used to lock/unlock the remaining closures. When a user wishes to lock the vehicle, he/she actuates the identification means a second time to trigger the locking of all of the latches 216, 218 if an “active” AD is used. If a periodic signalling AD 226 is used, locking is triggered once the receiver 244 fails to receive a signal from the AD 226 for a predetermined period of time.

While the second embodiment has been described with reference to a powered AD 226, it should be appreciated that if a suitable transmitter (not shown) were to be provided, the access control system of the this embodiment could be used with a non-powered AD 26 similar to that disclosed in the previous embodiment. Preferably, the transmitter may be provided in the middle of directional receivers 212a, 212b, 212c and 212d.

In one aspect of the invention, the direction sensing described above operates in conjunction with means to time the period for which an active AD 226 is actuated to ensure the correct doors are unlocked.

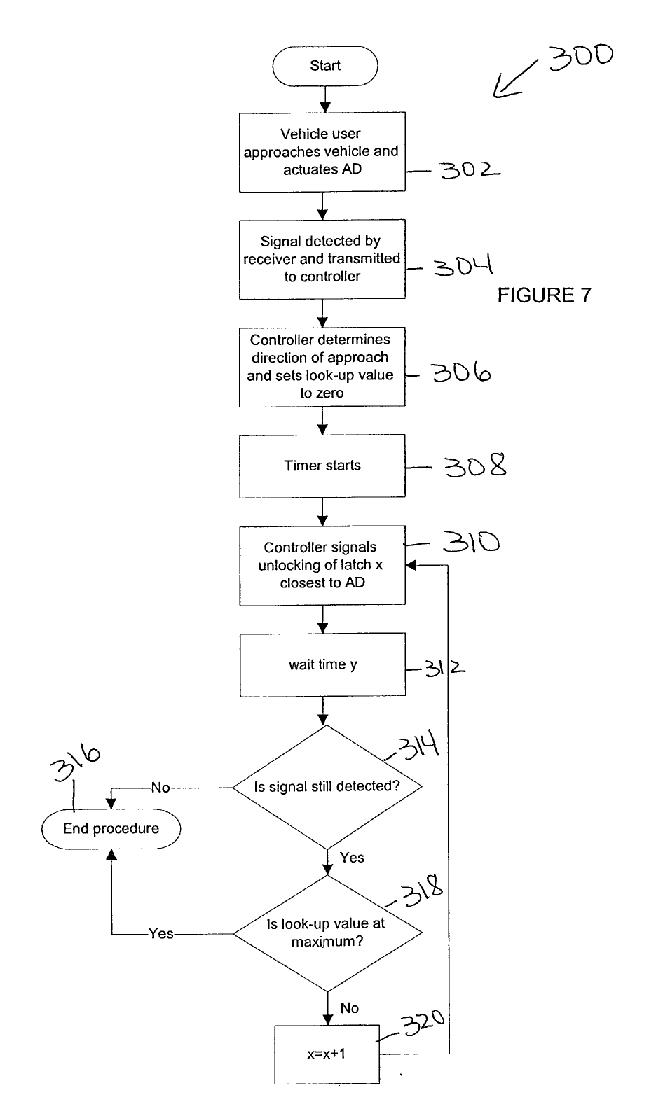

Turning now to FIG. 7, operation of the access control system 210 is illustrated as a flow chart 300. In use, a vehicle user actuates their AD 226 and a signal is transmitted by one of the receivers 212a, 212b, 212c, 212d to controller 224. In turn, the controller 224 sets a look-up value for the latch x to 0 and starts a timer that is associated with the controller 224. The look-up values stored by memory 224 are summarized by Table 1 below.

TABLE 1

| Lock x | Time y□ |
|---|---|
| Latch 0 = Driver 14a side or front passenger | Time 0 = 1 s |
| door 14d closest to authorization device 226. | |
| Latch 1 = Passenger door behind either front | Time 1 = 1 s |
| driver side 14a or front passenger door 14d | |
| Latch 2 = Remaining passenger compartment | Time 2 = 1 s |
| doors | |
| Latch 3 = Storage compartment door 129 | |

Thus, if the vehicle user approaches the driver's door and actuates their AD 226 (block 302), the signal from the AD 226 is detected by at least one of the receivers 212a, 212b, 212c, 212d and is sent to the controller 224 (block 304). A timer then starts (block 308) and the controller 224 signals the door latch 16a to unlock (in a RHD vehicle) immediately thereafter (block 310), having determined the direction of approach due to the signal from the AD 226 having been detected by, for example, receiver 212b in block 306. The controller 224 then waits a time y which for latch 0 equates to 1 second (block 312). If, after this time y, the AD 226 is no longer actuated (block 314), the controller 224 ends the unlocking procedure. If, however, the AD 226 is still actuated (block 316), the controller 224 then checks whether the look-up value for latch x is at its maximum value, which would indicate that all of the latches have been unlocked (block 318). If this is the case, the controller 224 ends the unlocking procedure (block, 316). However, if the maximum has not been reached, the controller then refers to the next latch x in the table (block 320), which in this example is the latch corresponding to the passenger door 214b behind the driver's door 214a, and signals the left front door lock actuator to unlock the latch 216b, and then waits a time y which for lock 1 again equates to 1 second (block 312). This procedure is then repeated until either the user has decided that sufficient latches have been unlocked and he/she can thus cease actuating the AD 226, or all of the latches have been unlocked and the procedure also therefore ends. Means to provide an audible or visible indication (not shown) of the latches that are unlocked may be provided.

Once seated in the vehicle 12, vehicle users may override the current locked state of any of the closures by actuating the manual override 230. This may be in the form of a conventional sill button in relation to the vehicle side doors 214a, 214b, 214c, 214d or may be one or more electrical switches actuatable by the vehicle user. To lock the vehicle after exit, the user actuates the AD 226 and in response the controller 224 signals the locking of the latches 216a, 216b, 216c, 216d and 220 for all of the closures.

It should be understood that numerous changes may be made within the scope of the present invention. For example, the transmitter and receiver may be physically separated from one another. The receivers of the second embodiment may also be mutually separated so as to have, for example, receivers proximate the front, rear and side windows. Rather than determining the location of a person relative to the vehicle, the system of the first embodiment could be used to track the vector of a person walking towards a vehicle and from this determine the appropriate door to be unlocked. The system may also unlatch the closures by being connected to corresponding power latch mechanisms. This would be particularly advantageous in the case of a rear boot/trunk lid as they are often not provided with an external latch release means. The system may enable closures to be unlocked sequentially. For example, a user may first walk to the boot, causing the boot lid to be unlocked, and the subsequent walk to the driver's door causing this to then be unlocked. The controller may also output to actuators and the like for adjusting the seating, steering wheel and mirror positions, for example, in order to personalize the vehicle settings for a particular user carrying a response device. The system may be retrofittable to vehicles or may be fitted at the time of vehicle manufacture. The system may be adapted for vehicles having fewer or more closures than shown in the Figures. Access to the vehicle may be provided by a user supplying biometric data to the vehicle such a fingerprint or a voice input, in which case the term “authorization device” should be construed to include such data.

It should be understood that various alternatives to the embodiments of the invention described herein may be employed in practicing the invention. It is intended that the following claims define the scope of the invention and that the method and apparatus within the scope of these claims and their equivalents be covered thereby.

We claim:

1. An access control system for a vehicle having at least two closures, the system being controllable by an authorization device, comprising:
a receiver that receives an input signal from the authorization device and detects an angular position of the authorization device relative to the receiver; and
a controller that determines which one of said at least two closures to open and that determines at least one additional closure of said at least two closures to be opened in accordance with predetermined criteria corresponding to a time period from which the input signal is received from the authorization device.

2. A system according to claim 1, wherein the controller signals at least one of said at least two closures corresponding to the angular position of the authorization device to open.

3. A system according to claim 1, wherein the receiving is directional and rotates to determine the angular position of the authorization device.

4. A system according to claim 3 further comprising a rotary position encoder coupled to the receiver arranged to determine the angular position.

5. A system according to claim 1, wherein the receiver is stationary.

6. A system according to claim 5, wherein the receiver comprises at least two directional receivers, each directional receiver arranged to detect a signal from authorization device over a predetermined angle.

7. A system according to claim 6, wherein said at least two directional receivers comprise first, second, and third directional receivers.

8. A system according to claim 6, wherein the first and second receivers can receive signals over angles corresponding substantially to first and second sides of the vehicle, respectively.

9. A system according to claim 6, wherein the third receiver can receive signals over an angle corresponding substantially to a rear of the vehicle.

10. A system according to claim 2, wherein the controller signals one of said at least two closures closest to the authorization device to open if the input signal is shorter than a first predetermined duration.

11. A system according to claim 10, wherein the controller signals at least one additional closure to open if the input signal is longer than the first predetermined duration.

12. A system according to claim 10, wherein the controller signals all closures on the vehicle to open if the input signal is longer than a second predetermined duration.

13. A vehicle incorporating an access control system controllable by an authorization device, comprising:
a plurality of closures;
a receiver disposed on the vehicle, wherein the receiver receives an input signal from the authorization device and detects an angular position of the authorization device relative to the receiver; and
a controller that determines which one of said plurality of closures to open and that determines at least one additional closure of said plurality of closures to open in accordance with predetermined criteria corresponding to a time period from which the input signal is received from the authorization device.

14. A vehicle according to claim 13, wherein the controller signals at least one of said at least two closures corresponding to the angular position of the authorization device to open.

15. A vehicle according to claim 13, wherein the receiving is directional and rotates to determine the angular position of the authorization device.

16. A vehicle according to claim 13, wherein the receiver is stationary.

17. A vehicle according to claim 16, wherein the receiver comprises at least two directional receivers, each directional receiver arranged to detect a signal from authorization device over a predetermined angle.

18. A vehicle according to claim 14, wherein the controller signals one of said at least two closures closest to the authorization device to open if the input signal is shorter than a first predetermined duration.

19. A vehicle according to claim 18, wherein the controller signals at least one additional closure to open if the input signal is longer than the first predetermined duration.

20. A vehicle according to claim 18, wherein the controller signals all of said plurality of closures on the vehicle to open if the input signal is longer than a second predetermined duration.

21. A method of opening at least one closure on a vehicle having at least two closures, the method comprising:
receiving an input signal from an authorization device into a receiver;
determining an angular position of the authorization device relative to the receiver and a duration of the input signal;
comparing the angular position and the duration with predetermined criteria; and
opening at least one closure based on a result from the comparing act.

22. An access control system for a vehicle having at least two closures and controllable by an authorization device having one of a first authorization level and a second authorization level, the system comprising:
a receiver that receives an input signal from the authorization device and detects an angular position of the authorization device relative to the receiver; and
a controller that detects whether the authorization device has the first authorization level and the second authorization level, wherein the controller does not signal opening of at least one of said at least two closures if the authorization device has the first authorization level and signals opening of at least one of said at least two closures if the authorization device has the second authorization level.
